(19) United States
(12) Patent Application Publication
(10) Pub. No.: US 2022/0267629 A1
(43) Pub. Date: Aug. 25, 2022

(54) THREE-DIMENSIONAL PRINTING WITH SCENT AGENTS

(71) Applicant: Hewlett-Packard Development Company, L.P., Spring, TX (US)

(72) Inventors: Emre Hiro Discekici, San Diego, CA (US); Shannon Reuben Woodruff, San Diego, CA (US); Carolin Fleischmann, San Diego, CA (US)

(73) Assignee: Hewlett-Packard Development Company, L.P., Spring, TX (US)

(21) Appl. No.: 17/629,018

(22) PCT Filed: Sep. 4, 2019
(86) PCT No.: PCT/US2019/049423

§ 371 Date: Jan. 21, 2022

(51) Int. Cl. C09D 11/38; B33Y 10/00; B33Y 70/00; B29C 64/165; C09D 11/10

(52) U.S. Cl. CPC C09D 11/38; B33Y 10/00; B33Y 70/00; B29C 64/165; C09D 11/10; B29K 2105/0029

(57) ABSTRACT

The present disclosure describes multi-fluid kits for three-dimensional printing, three-dimensional printing kits, and methods of making three-dimensional printed articles. In one example, a multi-fluid kit for three-dimensional printing can include a fusing agent and a scent agent. The fusing agent can include water and a radiation absorber. The radiation absorber can absorb radiation energy and convert the radiation energy to heat. The scent agent can include water and a scent additive. The scent additive can be chemically stable at an elevated temperature from about 70° C. to about 350° C.

### BACKGROUND

Methods of three-dimensional (3D) digital printing, a type of additive manufacturing, have continued to be developed over the last few decades. However, systems for 3D printing have historically been very expensive, though those expenses have been coming down to more affordable levels recently. In general, 3D printing technology can shorten the product development cycle by allowing rapid creation of prototype models for reviewing and testing. Unfortunately, the concept has been somewhat limited with respect to commercial production capabilities because the range of materials used in 3D printing is likewise limited. Accordingly, it can be difficult to 3D print functional parts with desired properties such as mechanical strength, visual appearance, and so on. Nevertheless, several commercial sectors such as aviation and the medical industry have benefitted from the ability to rapidly prototype and customize parts for customers.

### BRIEF DESCRIPTION OF THE DRAWINGS

FIG. 1 is a schematic view of an example multi-fluid kit for three-dimensional printing in accordance with examples of the present disclosure.

FIG. 2 is a schematic view of an example three-dimensional printing kit in accordance with examples of the present disclosure.

FIG. 3 is a schematic view of another example three-dimensional printing kit in accordance with examples of the present disclosure.

FIG. 4 is a schematic view of yet another example three-dimensional printing kit in accordance with examples of the present disclosure.

FIGS. 5A-5C show a schematic view of an example three-dimensional printing process using an example three-dimensional printing kit in accordance with examples of the present disclosure.

FIG. 6 is a flowchart illustrating an example method of making a three-dimensional printed article in accordance with examples of the present disclosure.

### DETAILED DESCRIPTION

The present disclosure describes multi-fluid kits for three-dimensional printing that include scent agents for making scented three-dimensional printed articles. The present disclosure also describes three-dimensional printing kits and methods of making three-dimensional printed articles. In one example, a multi-fluid kit for three-dimensional printing can include a fusing agent and a scent agent. The fusing agent can include water and a radiation absorber, wherein the radiation absorber absorbs radiation energy and converts the radiation energy to heat. The scent agent can include water and a scent additive, wherein the scent additive is chemically stable at an elevated temperature from about 70° C. to about 350° C. In some examples, the scent additive can be dissolved in the water of the scent agent. In further examples, the scent additive can be present in the scent agent in an amount from about 0.05 wt % to about 10 wt % based on the total weight of the scent agent. In certain examples, the scent additive can include a furanone derivative. In some examples, the scent additive can have one of the following general structures:

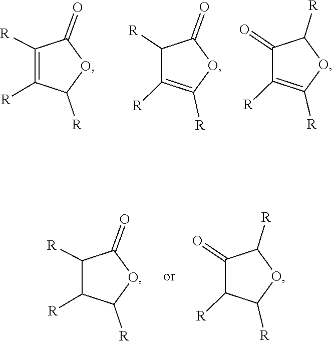

where the R groups are independently hydrogen, methyl, ethyl, hydroxyl, methoxy, ethoxy, acetate, propionate, or butyrate. In other examples, the multi-fluid kit can also include a detailing agent, wherein the detailing agent includes a detailing compound, wherein the detailing compound reduces the temperature of powder bed material onto which the detailing agent is applied.

The present disclosure also describes three-dimensional printing kits. In one example, a three-dimensional printing kit can include a powder bed material, a fusing agent to selectively apply to the powder bed material, and a scent additive. The powder bed material can include polymer particles. The fusing agent can include water and a radiation absorber to absorb radiation energy and convert the radiation energy to heat. The scent additive can be included in the fusing agent or in a separate scent agent to selectively apply to the powder bed material. The scent additive can be chemically stable at a melting point temperature of the polymer particles. In certain examples, the polymer particles can include polyamide 6, polyamide 9, polyamide 11, polyamide 12, polyamide 66, polyamide 612, thermoplastic polyamide, polyamide copolymer, polyethylene, thermoplastic polyurethane, polypropylene, polyester, polycarbonate, polyether ketone, polyacrylate, polystyrene, polyvinylidene fluoride, polyvinylidene fluoride copolymer, poly(vinylidene fluoride-trifluoroethylene), poly(vinylidene fluoride-trifluoroethylene-chlorotrifluoroethylene), wax, or a combination thereof. In other examples, the scent additive can be present in the separate scent agent in an amount from about 0.05 wt % to about 10 wt % based on the total weight of the scent agent, and the scent agent can also include water. In some examples, the scent additive can include a furanone derivative. In certain examples, the scent additive can have any of the general structures depicted above.

The present disclosure also describes methods of making three-dimensional printed articles. In one example, a method of making a three-dimensional printed article can include iteratively applying individual layers of a powder bed material to a powder bed, wherein the powder bed material includes polymer particles. A fusing agent can be selectively applied onto the individual layers of powder bed material based on a three-dimensional object model. The fusing agent can include water and a radiation absorber. The radiation absorber can absorb radiation energy and convert the radiation energy to heat. A scent additive can also be selectively applied to the powder bed material based on the three-dimensional object model. The scent additive can be chemically stable at a melting point temperature of the polymer particles. The powder bed can be exposed to radiation energy to selectively fuse the polymer particles in contact with the radiation absorber at individual layers and thereby form the three-dimensional printed article. In some examples, applying the scent additive can include applying a scent agent that is separate from the fusing agent, wherein the scent additive is present in the scent agent in an amount from about 0.05 wt % to about 10 wt % based on the total weight of the scent agent. The scent agent can also include water, and the scent additive can be dissolved in the water. In other examples, applying the fusing agent and scent additive can include ejecting the fusing agent from jetting architecture, wherein the scent additive is included in the fusing agent, or ejecting the fusing agent and a separate scent agent from jetting architecture, wherein the scent additive is included in the separate scent agent. In certain examples, the scent additive can include a furanone derivative.

The multi-fluid kits, three-dimensional printing kits, and methods described herein can be used to make three-dimensional (3D) printed articles that include a scent additive to provide a particular scent to the finished 3D printed articles. The fluids and materials described herein can be used, in some examples, with certain 3D printing processes that involve fusing layers of polymer powder to form solid layers of a 3D printed article. In one process, a fusing agent can be jetted onto a powder bed of polymer particles. The fusing agent can include a radiation absorber, which can be a material that absorbs radiant energy and converts the energy to heat. Radiant energy can be applied to the powder bed to heat and fuse the polymer particles on which the fusing agent was applied.

In some cases, a scent additive can be added to the fusing agent or as a part of another jettable fluid agent. The scented fusing agent or separate scent agent can be used during the 3D printing process so that the finished 3D printed article can have the scent of the particular scent additive used. This can be useful for many different types of 3D printed articles in which a characteristic scent is desired. For example, 3D printed dental equipment can include a fragrance or flavoring agent such as a mint scent or flavor. Other examples can include 3D printed articles having a fragrance designed to cover up other odors. For example, customized insoles for footwear can be produced through 3D printing. Such 3D printed insoles can include a fragrance to mitigate unpleasant foot odors. Other 3D printed devices for personal wear, such as clothing items, prosthetics, and so on can also be formed with a fragrance to mask body odors, for example. In further examples, it can be desired to impart a characteristic fragrance to a 3D printed article for aesthetic appeal and to provide a particular end-user experience. Accordingly, a wide variety of 3D printed articles can be made with a wide variety of scents using the materials and methods described herein.

In some cases, multiple different scented agents can be used together. 3D printed articles can be formed with different scents located in different portions of the article. In other examples, multiple different scents can be used in the same area to create a mixed scent or a new scent that results from the combination of multiple scents. Because the build material is unscented and the scent additive is contained in a fluid agent to be selectively applied to the build material, it can be easy to switch scents or use multiple different scents without changing the build material. In some examples, scented agents can be used selectively to form some 3D printed articles that are scent while simultaneously forming other 3D printed articles that are unscented. Thus, adding scent additives to fluid agents for use in the 3D printing process can provide a wide degree of flexibility in making scented and unscented 3D printed articles.

### Multi-Fluid Kits for Three-Dimensional Printing

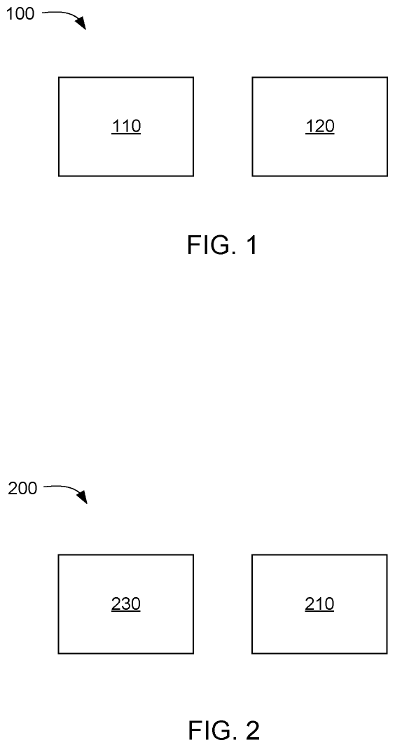

With this description in mind, FIG. 1 shows a schematic of an example multi-fluid kit for three-dimensional printing 100. The kit includes a fusing agent 110 and a scent agent 120. The fusing agent can include water and a radiation absorber. The radiation absorber can absorb radiation energy and convert the radiation energy to heat. The scent agent can include water and a scent additive. The scent additive can be chemically stable at an elevated temperature from about 70° C. to about 350° C.

As used herein, “chemically stable” can be used with reference to the scent additive to describe scent additives that do not chemically decompose or react to form different chemical compounds when heated to a particular elevated temperature. In some examples, the temperature can be the melting point temperature of polymer powder that is used together with the scent agent. That is, the scent agent can be chemically stable at the melting point temperature of the polymer powder. Therefore, when the polymer powder is heated sufficiently to fuse the polymer powder together (which may be at or near the melting point temperature) the scent additive can remain effective. Alternatively, if the scent additive begins to decompose or react at the melting point temperature, the decomposition or reaction can be sufficiently slow that less than 10 wt % of scent additive decomposes or reacts while the polymer particles are being fused together. In some examples, the polymer powder can have a melting point temperature from about 70° C. to about 350° C. Therefore, in some examples, the scent additive can be chemically stable at a temperature from about 70° C. to about 350° C. In many cases, the scent additive can be chemically stable at the melting point of the polymer particles, and the scent additive can also be chemically stable to a temperature significantly higher than the melting point of the polymer particles.

In some examples, the multi-fluid kit can also include a detailing agent. The detailing agent can include a detailing compound, which is a compound that can reduce the temperature of powder bed material onto which the detailing agent is applied. In some examples, the detailing agent can be applied around edges of the area where the fusing agent is applied. This can prevent powder bed material around the edges from caking due to heat from the area where the fusing agent was applied. The detailing agent can also be applied in the same area where fusing was applied in order to control the temperature and prevent excessively high temperatures when the powder bed material is fused.

### Three-Dimensional Printing Kits

The present disclosure also describes three-dimensional printing kits. In some examples, the three-dimensional printing kits can include materials that can be used in the three-dimensional printing processes described herein. FIG. 2 shows a schematic illustration of one example three-dimensional printing kit 200 in accordance with examples of the present disclosure. The kit includes a powder bed material 230 including polymer particles and a fusing agent 210 to selectively apply to the powder bed material. In this example, a scent additive is included in the fusing agent so that the 3D printed article formed using the fusing agent will have the scent of the scent additive. The scent additive can be chemically stable at the melting point temperature of the polymer particles. The fusing agent also includes water and a radiation absorber to absorb radiation energy and convert the radiation energy to heat.

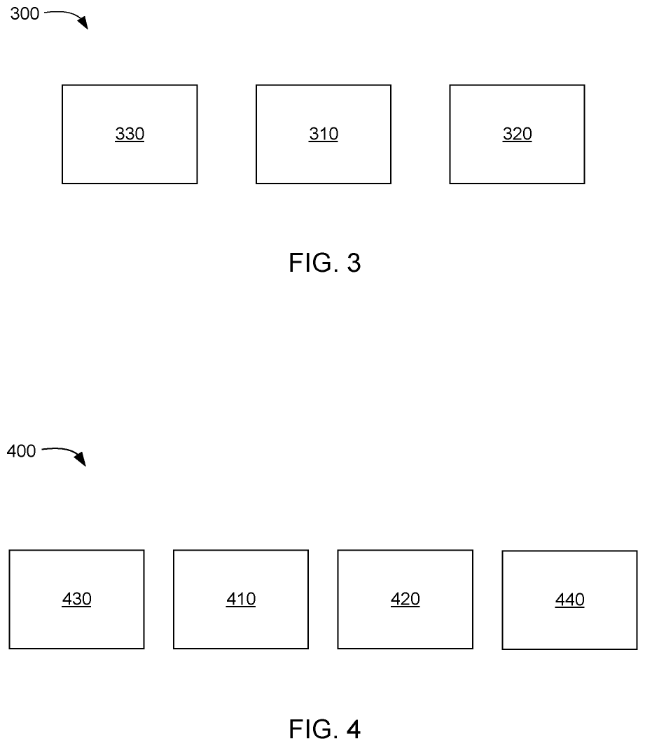

In further examples, a three-dimensional printing kit can include multiple fluid agents, such as any combination of a fusing agent, a detailing agent, and a scent agent. FIG. 3 is a schematic illustration of one example three-dimensional printing kit 300 that includes a powder bed material 330, a fusing agent 310, and a scent agent 320. The fusing agent can include water and a radiation absorber that absorbs radiation energy and converts the radiation energy to heat. The scent agent can include water and a scent additive that is chemically stable at the melting point temperature of the polymer particles in the powder bed material.

While the fusing agent and the scent agent can be two separate fluid agents in some examples, in other examples the scent agent can include a radiation absorber so that the scent agent can function as a fusing agent. Thus, in some examples, the three-dimensional printing kit can include a scent agent that can also function as a fusing agent, and no separate fusing agent may be included in the kit.

FIG. 4 is a schematic illustration of yet another example three-dimensional printing kit 400 that includes a powder bed material 430, a fusing agent 410, a scent agent 420, and a detailing agent 440. The fusing agent, scent agent, and detailing agent can include the ingredients described above.

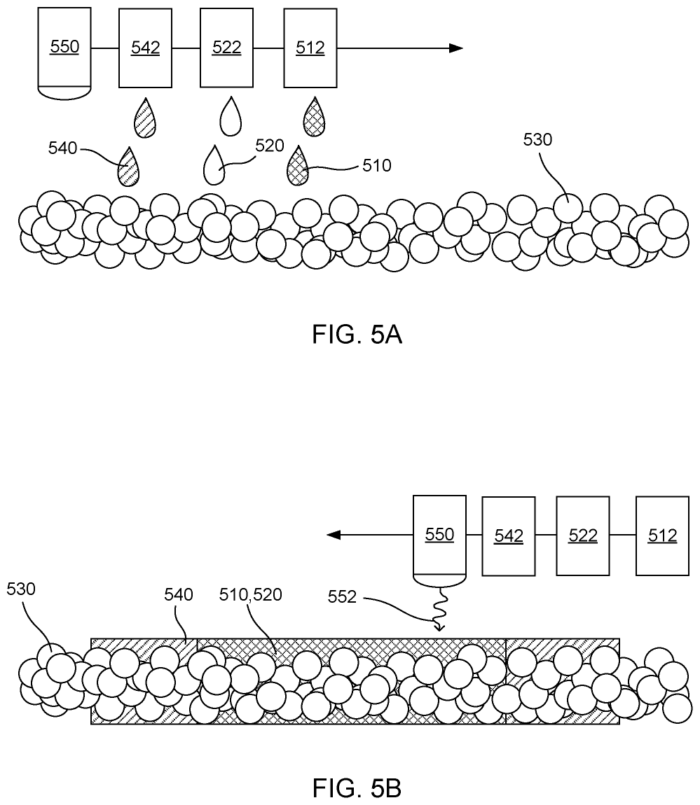

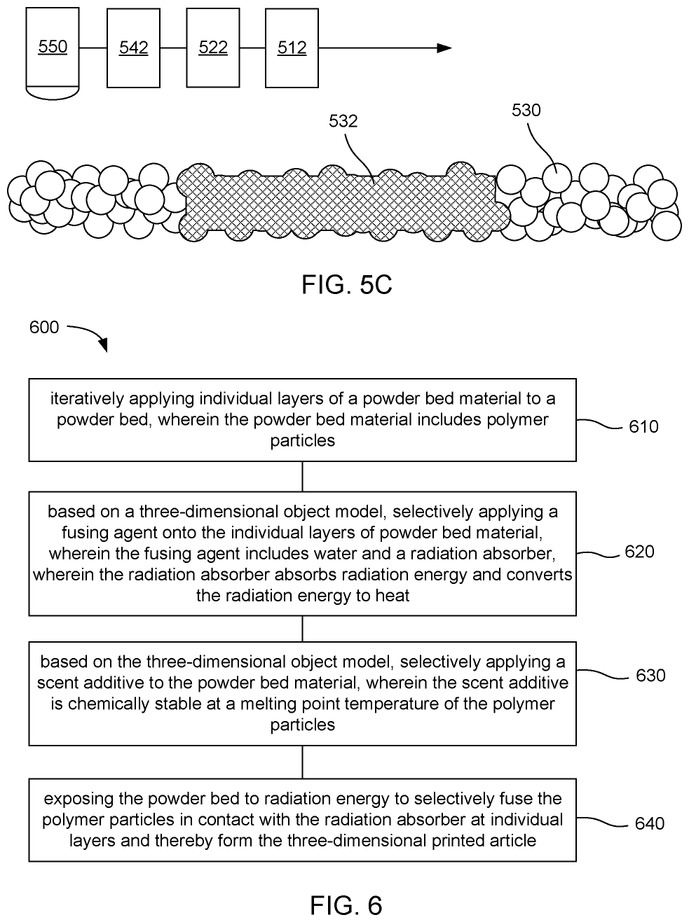

To illustrate the use of the three-dimensional printing kits and multi-fluid kits described herein, FIGS. 5A-5C illustrate one example of using a three-dimensional printing kit to form a 3D printed article. In FIG. 5A, a fusing agent 510, a scent agent 520, and a detailing agent 540 are jetted onto a layer of powder bed material 530. The fusing agent is jetted from a fusing agent ejector 512, the scent agent is jetted from a scent agent ejector 522, and the detailing agent is jetted from a detailing agent ejector 542. These fluid ejectors can move across the layer of powder bed material to selectively jet fusing agent on areas that are to be fused, while the detailing agent can be jetted onto areas that are to be cooled. The scent agent can be jetted in areas where the particular scent of the scent additive is desired. A radiation source 550 can also move across the layer of powder bed material.

FIG. 5B shows the layer of powder bed material 530 after the fusing agent 510 and the scent agent 520 have been jetted onto an area of the layer that is to be fused. Additionally, the detailing agent 540 has been jetted onto areas adjacent to the edges of the area to be fused. In this figure, the radiation source 550 is shown emitting radiation 552 toward the layer of polymer particles. The fusing agent can include a radiation absorber that can absorb this radiation and convert the radiation energy to heat.

FIG. 5C shows the layer of powder bed material 530 with a fused portion 532 where the fusing agent was jetted. This portion has reached a sufficient temperature to fuse the polymer particles together to form a solid polymer matrix. This portion can also include the scent additive from the scent agent, which was also jetted in the same area as the fusing agent. The scent additive can be chemically stable at the melting temperature of the polymer particles, so the scent additive can remain effective after the polymer particles have been fused. The area where the detailing agent was jetted remains as loose polymer particles.

In various examples, the scent agent can be jetted onto portions of the individual powder bed material layers to form a portion of the final 3D printed article that has the scent additive embedded in the fused polymer matrix. In some examples, the scent agent can be jetted in all the same areas where the fusing agent is jetted (or the scent agent may be used as the fusing agent in some cases, as mentioned above, or alternatively the fusing agent can include a scent additive so that the fusing agent also acts as a scent agent) and the resulting 3D printed article can have the scent additive distributed throughout the entire article.

In other examples, the scent agent may be selectively jetted in some areas and not in other areas where the fusing agent was jetted. This can result in a 3D printed article that has some portions without scent additive and some portions with scent additive. In still further examples, additional scent agents with different scent additives can be used to make multiple portions of the 3D printed article with multiple different scents.

### Powder Bed Material

In certain examples, the powder bed material can include polymer particles having a variety of shapes, such as substantially spherical particles or irregularly-shaped particles. In some examples, the polymer powder can be capable of being formed into 3D printed objects with a resolution of about 20 μm to about 100 μm, about 30 μm to about 90 μm, or about 40 μm to about 80 μm. As used herein, “resolution” refers to the size of the smallest feature that can be formed on a 3D printed object. The polymer powder can form layers from about 20 μm to about 100 μm thick, allowing the fused layers of the printed part to have roughly the same thickness. This can provide a resolution in the z-axis (i.e., depth) direction of about 20 μm to about 100 μm. The polymer powder can also have a sufficiently small particle size and sufficiently regular particle shape to provide about 20 μm to about 100 μm resolution along the x-axis and y-axis (i.e., the axes parallel to the top surface of the powder bed). For example, the polymer powder can have an average particle size from about 20 μm to about 100 μm. In other examples, the average particle size can be from about 20 μm to about 50 μm. Other resolutions along these axes can be from about 30 μm to about 90 μm or from 40 μm to about 80 μm.

The polymer powder can have a melting or softening point from about 70° C. to about 350° C. In further examples, the polymer can have a melting or softening point from about 150° C. to about 200° C. A variety of thermoplastic polymers with melting points or softening points in these ranges can be used. For example, the polymer powder can be polyamide 6 powder, polyamide 9 powder, polyamide 11 powder, polyamide 12 powder, polyamide 6/6 powder, polyamide 6/12 powder, thermoplastic polyamide powder, polyamide copolymer powder, polyethylene powder, wax, thermoplastic polyurethane powder, acrylonitrile butadiene styrene powder, amorphous polyamide powder, polymethylmethacrylate powder, ethylene-vinyl acetate powder, polyarylate powder, silicone rubber, polypropylene powder, polyester powder, polycarbonate powder, copolymers of polycarbonate with acrylonitrile butadiene styrene, copolymers of polycarbonate with polyethylene terephthalate, polyether ketone powder, polyacrylate powder, polystyrene powder, polyvinylidene fluoride powder, polyvinylidene fluoride copolymer powder, poly(vinylidene fluoride-trifluoroethylene) powder, poly(vinylidene fluoride-trifluoroethylene-chlorotrifluoroethylene) powder, or mixtures thereof. In a specific example, the polymer powder can be polyamide 12, which can have a melting point from about 175° C. to about 200° C. In another specific example, the polymer powder can be thermoplastic polyurethane.

The thermoplastic polymer particles can also in some cases be blended with a filler. The filler can include inorganic particles such as alumina, silica, fibers, carbon nanotubes, or combinations thereof. When the thermoplastic polymer particles fuse together, the filler particles can become embedded in the polymer, forming a composite material. In some examples, the filler can include a free-flow agent, anti-caking agent, or the like. Such agents can prevent packing of the powder particles, coat the powder particles and smooth edges to reduce inter-particle friction, and/or absorb moisture. In some examples, a weight ratio of thermoplastic polymer particles to filler particles can be from about 100:1 to about 1:2 or from about 5:1 to about 1:1.

### Fusing Agents

The multi-fluid kits and three-dimensional printing kits described herein can include a fusing agent to be applied to the polymer build material. The fusing agent can include a radiation absorber that can absorb radiant energy and convert the energy to heat. In certain examples, the fusing agent can be used with a powder bed material in a particular 3D printing process. A thin layer of powder bed material can be formed, and then the fusing agent can be selectively applied to areas of the powder bed material that are desired to be consolidated to become part of the solid 3D printed object. The fusing agent can be applied, for example, by printing such as with a fluid ejector or fluid jet printhead. Fluid jet printheads can jet the fusing agent in a similar way to an inkjet printhead jetting ink. Accordingly, the fusing agent can be applied with great precision to certain areas of the powder bed material that are desired to form a layer of the final 3D printed object. After applying the fusing agent, the powder bed material can be irradiated with radiant energy. The radiation absorber from the fusing agent can absorb this energy and convert it to heat, thereby heating any polymer particles in contact with the radiation absorber. An appropriate amount of radiant energy can be applied so that the area of the powder bed material that was printed with the fusing agent heats up enough to melt the polymer particles to consolidate the particles into a solid layer, while the powder bed material that was not printed with the fusing agent remains as a loose powder with separate particles.

In some examples, the amount of radiant energy applied, the amount fusing agent applied to the powder bed, the concentration of radiation absorber in the fusing agent, and the preheating temperature of the powder bed (i.e., the temperature of the powder bed material prior to printing the fusing agent and irradiating) can be tuned to ensure that the portions of the powder bed printed with the fusing agent will be fused to form a solid layer and the unprinted portions of the powder bed will remain a loose powder. These variables can be referred to as parts of the “print mode” of the 3D printing system. Generally, the print mode can include any variables or parameters that can be controlled during 3D printing to affect the outcome of the 3D printing process.

Generally, the process of forming a single layer by applying fusing agent and irradiating the powder bed can be repeated with additional layers of fresh powder bed material to form additional layers of the 3D printed article, thereby building up the final object one layer at a time. In this process, the powder bed material surrounding the 3D printed article can act as a support material for the object. When the 3D printing is complete, the article can be removed from the powder bed and any loose powder on the article can be removed.

Accordingly, in some examples, the fusing agent can include a radiation absorber that is capable of absorbing electromagnetic radiation to produce heat. The radiation absorber can be colored or colorless. In various examples, the radiation absorber can be a pigment such as carbon black pigment, glass fiber, titanium dioxide, clay, mica, talc, barium sulfate, calcium carbonate, a near-infrared absorbing dye, a near-infrared absorbing pigment, a conjugated polymer, a dispersant, or combinations thereof. Examples of near-infrared absorbing dyes include aminium dyes, tetraaryldiamine dyes, cyanine dyes, pthalocyanine dyes, dithiolene dyes, and others. In further examples, radiation absorber can be a near-infrared absorbing conjugated polymer such as poly(3,4-ethylenedioxythiophene)-poly(styrenesulfonate) (PEDOT:PSS), a polythiophene, poly(p-phenylene sulfide), a polyaniline, a poly(pyrrole), a poly(acetylene), poly(p-phenylene vinylene), polyparaphenylene, or combinations thereof. As used herein, “conjugated” refers to alternating double and single bonds between atoms in a molecule. Thus, “conjugated polymer” refers to a polymer that has a backbone with alternating double and single bonds. In many cases, the radiation absorber can have a peak absorption wavelength in the range of about 800 nm to about 1400 nm.

A variety of near-infrared pigments can also be used. Non-limiting examples can include phosphates having a variety of counterions such as copper, zinc, iron, magnesium, calcium, strontium, the like, and combinations thereof. Non-limiting specific examples of phosphates can include M₂P₂O₇, M₄P₂O₉, M₅P₂O₁₀, M₃(PO₄)₂, M(PO₃)₂, M₂P₄O₁₂, and combinations thereof, where M represents a counterion having an oxidation state of +2, such as those listed above or a combination thereof. For example, M₂P₂O₇ can include compounds such as Cu₂P₂O₇, Cu/MgP₂O₇, Cu/ZnP₂O₇, or any other suitable combination of counterions. It is noted that the phosphates described herein are not limited to counterions having a +2 oxidation state. Other phosphate counterions can also be used to prepare other suitable near-infrared pigments.

Additional near-infrared pigments can include silicates. Silicates can have the same or similar counterions as phosphates. One non-limiting example can include M₂SiO₄, M₂Si₂O₆, and other silicates where M is a counterion having an oxidation state of +2. For example, the silicate M₂Si₂O₆ can include Mg₂Si₂O₆, Mg/CaSi₂O₆, MgCuSi₂O₆, Cu₂Si₂O₆, Cu/ZnSi₂O₆, or other suitable combination of counterions. It is noted that the silicates described herein are not limited to counterions having a +2 oxidation state. Other silicate counterions can also be used to prepare other suitable near-infrared pigments.

In further examples, the radiation absorber can include a metal dithiolene complex. Transition metal dithiolene complexes can exhibit a strong absorption band in the 600 nm to 1600 nm region of the electromagnetic spectrum. In some examples, the central metal atom can be any metal that can form square planer complexes. Non-limiting specific examples include complexes based on nickel, palladium, and platinum.

In further examples, the radiation absorber can include a tungsten bronze or a molybdenum bronze. In certain examples, tungsten bronzes can include compounds having the formula MₓWO₃, where M is a metal other than tungsten and x is equal to or less than 1. Similarly, in some examples, molybdenum bronzes can include compounds having the formula MₓMoO₃, where M is a metal other than molybdenum and x is equal to or less than 1.

In alternative examples, the radiation absorber can preferentially absorb ultraviolet radiation. In some examples, the radiation absorber can absorb radiation in wavelength range from about 300 nm to about 400 nm. In certain examples, the amount of electromagnetic energy absorbed by the fusing agent can be quantified as follows: a layer of the fusing agent having a thickness of 0.5 μm after liquid components have been removed can absorb from 90% to 100% of radiant electromagnetic energy having a wavelength within a wavelength range from about 300 nm to about 400 nm. The radiation absorber may also absorb little or no visible light, thus making the radiation absorber transparent to visible light. In certain examples, the 0.5 μm layer of the fusing agent can absorb from 0% to 20% of radiant electromagnetic energy in a wavelength range from above about 400 nm to about 700 nm. Non-limiting examples of ultraviolet absorbing radiation absorbers can include nanoparticles of titanium dioxide, zinc oxide, cerium oxide, indium tin oxide, or a combination thereof. In some examples, the nanoparticles can have an average particle size from about 2 nm to about 300 nm, from about 10 nm to about 100 nm, or from about 10 nm to about 60 nm.

A dispersant can be included in the fusing agent in some examples. Dispersants can help disperse the radiation absorbing pigments described above. In some examples, the dispersant itself can also absorb radiation. Non-limiting examples of dispersants that can be included as a radiation absorber, either alone or together with a pigment, can include polyoxyethylene glycol octylphenol ethers, ethoxylated aliphatic alcohols, carboxylic esters, polyethylene glycol ester, anhydrosorbitol ester, carboxylic amide, polyoxyethylene fatty acid amide, poly (ethylene glycol) p-isooctyl-phenyl ether, sodium polyacrylate, and combinations thereof.

The amount of radiation absorber in the fusing agent can vary depending on the type of radiation absorber. In some examples, the concentration of radiation absorber in the fusing agent can be from about 0.1 wt % to about 20 wt %. In one example, the concentration of radiation absorber in the fusing agent can be from about 0.1 wt % to about 15 wt %. In another example, the concentration can be from about 0.1 wt % to about 8 wt %. In yet another example, the concentration can be from about 0.5 wt % to about 2 wt %. In a particular example, the concentration can be from about 0.5 wt % to about 1.2 wt %. In one example, the radiation absorber can have a concentration in the fusing agent such that after the fusing agent is jetted onto the polymer powder, the amount of radiation absorber in the polymer powder can be from about 0.0003 wt % to about 10 wt %, or from about 0.005 wt % to about 5 wt %, with respect to the weight of the polymer powder.

In some examples, the fusing agent can be jetted onto the polymer powder build material using a fluid jetting device, such as inkjet printing architecture. Accordingly, in some examples, the fusing agent can be formulated to give the fusing agent good jetting performance. Ingredients that can be included in the fusing agent to provide good jetting performance can include a liquid vehicle. Thermal jetting can function by heating the fusing agent to form a vapor bubble that displaces fluid around the bubble, and thereby forces a droplet of fluid out of a jet nozzle. Thus, in some examples the liquid vehicle can include a sufficient amount of an evaporating liquid that can form vapor bubbles when heated. The evaporating liquid can be a solvent such as water, an alcohol, an ether, or a combination thereof.

In some examples, the liquid vehicle formulation can include a co-solvent or co-solvents present in total at from about 1 wt % to about 50 wt %, depending on the jetting architecture. Further, a non-ionic, cationic, and/or anionic surfactant can be present, ranging from about 0.01 wt % to about 5 wt %. In one example, the surfactant can be present in an amount from about 1 wt % to about 5 wt %. The liquid vehicle can include dispersants in an amount from about 0.5 wt % to about 3 wt %. The balance of the formulation can be purified water, and/or other vehicle components such as biocides, viscosity modifiers, materials for pH adjustment, sequestering agents, preservatives, and the like. In one example, the liquid vehicle can be predominantly water.

In some examples, a water-dispersible or water-soluble radiation absorber can be used with an aqueous vehicle. Because the radiation absorber is dispersible or soluble in water, an organic co-solvent may not be present, as it may not be included to solubilize the radiation absorber. Therefore, in some examples the fluids can be substantially free of organic solvent, e.g., predominantly water. However, in other examples a co-solvent can be used to help disperse other dyes or pigments, or enhance the jetting properties of the respective fluids. In still further examples, a non-aqueous vehicle can be used with an organic-soluble or organic-dispersible fusing agent.

Classes of co-solvents that can be used can include organic co-solvents including aliphatic alcohols, aromatic alcohols, diols, glycol ethers, polyglycol ethers, caprolactams, formamides, acetamides, and long chain alcohols. Examples of such compounds include 1-aliphatic alcohols, secondary aliphatic alcohols, 1,2-alcohols, 1,3-alcohols, 1,5-alcohols, ethylene glycol alkyl ethers, propylene glycol alkyl ethers, higher homologs (C₆-C₁₂) of polyethylene glycol alkyl ethers, N-alkyl caprolactams, unsubstituted caprolactams, both substituted and unsubstituted formamides, both substituted and unsubstituted acetamides, and the like. Specific examples of solvents that can be used include, but are not limited to, 2-pyrrolidinone, N-methylpyrrolidone, 2-hydroxyethyl-2-pyrrolidone, 2-methyl-1,3-propanediol, tetraethylene glycol, 1,6-hexanediol, 1,5-hexanediol and 1,5-pentanediol.

Regarding the surfactant that may be present, a surfactant or surfactants can be used, such as alkyl polyethylene oxides, alkyl phenyl polyethylene oxides, polyethylene oxide block copolymers, acetylenic polyethylene oxides, polyethylene oxide (di)esters, polyethylene oxide amines, protonated polyethylene oxide amines, protonated polyethylene oxide amides, dimethicone copolyols, substituted amine oxides, and the like. The amount of surfactant added to the fusing agent may range from about 0.01 wt % to about 20 wt %. Suitable surfactants can include, but are not limited to, liponic esters such as Tergitol™ 15-S-12, Tergitol™ 15-S-7 available from Dow Chemical Company (Michigan), LEG-1 and LEG-7; Triton™ X-100; Triton™ X-405 available from Dow Chemical Company (Michigan); and sodium dodecylsulfate.

Various other additives can be employed to enhance certain properties of the fusing agent for specific applications. Examples of these additives are those added to inhibit the growth of harmful microorganisms. These additives may be biocides, fungicides, and other microbial agents, which can be used in various formulations. Examples of suitable microbial agents include, but are not limited to, NUOSEPT® (Nudex, Inc., New Jersey), UCARCIDE™ (Union carbide Corp., Texas), VANCIDE® (R.T. Vanderbilt Co., Connecticut), PROXEL® (ICI Americas, New Jersey), and combinations thereof.

Sequestering agents, such as EDTA (ethylene diamine tetra acetic acid), may be included to eliminate the deleterious effects of heavy metal impurities, and buffer solutions may be used to control the pH of the fluid. From about 0.01 wt % to about 2 wt %, for example, can be used. Viscosity modifiers and buffers may also be present, as well as other additives to modify properties of the fluid as desired. Such additives can be present at from about 0.01 wt % to about 20 wt %.

As mentioned above, in some examples, the fusing agent can include the scent additive described herein. Thus, in some cases the fusing agent and the scent agent can be one and the same. The fusing agent can include the scent additive in an amount from about 0.05 wt % to about 10 wt % with respect to the total weight of the fusing agent, in some examples. In other examples, the fusing agent can include the scent additive in an amount from about 0.1 wt % to about 8 wt % or from about 0.5 wt % to about 5 wt %.

In certain further examples, the fusing agent can include from about 5 wt % to about 40 wt % organic co-solvent, from about 0 wt % to about 20 wt % high boiling point solvent, from about 0.1 wt % to about 1 wt % surfactant, from about 0.1 wt % to about 1 wt % anti-kogation agent, from about 0.01 wt % to about 1 wt % chelating agent, from about 0.01 wt % to about 1 wt % biocide, and from about 1 wt % to about 10 wt % carbon black pigment. The balance can be deionized water.

Scent Agents

In some examples, the multi-fluid kits or three-dimensional printing kits can include a scent agent. Generally, the scent agent can include water and a scent additive that is chemically stable at the melting point temperature of polymer particles with which the scent agent is used, such as from about 70° C. to about 350° C.

In some examples, the scent additive can be water soluble. As referred to herein, a water soluble scent additive can be sufficiently soluble in water that the amount of scent additive that can be dissolved in water is sufficient to provide a detectable scent in a finished 3D printed article if the solution of the scent agent is applied during 3D printing. In some examples, the scent additive can form a solution with water having 0.5 wt % scent additive or more, with respect to the entire weight of the solution. In further examples, the scent additive can form a solution with water having 1 wt % or more of the scent additive, 2 wt % or more, or 5 wt % or more of the scent additive. In other examples, the scent additive can be less soluble or insoluble in water. If the scent additive is not sufficiently soluble in water, then the scent agent may include a co-solvent to help dissolve the scent additive. In other examples, the scent agent can include a dispersant to disperse the scent additive in the scent agent.

In some examples, the scent additive can be a furanone derivative that has a desired scent. A variety of furanone derivatives can have different scents that mimic scents of foods, spices, or other desirable scents. As used herein, “furanone” refers to a chemical compound that includes the structure of a furan ring with an oxygen atom double bonded to one of the carbon atoms of the furan rings. Furanone derivatives can include such compounds with functional groups attached to carbons in the furan rings.

In certain examples, the scent additive can be a furanone derivative having one of the following general structures:

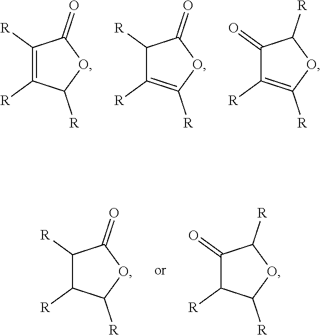

wherein the R groups are independently hydrogen, methyl, ethyl, hydroxyl, methoxy, ethoxy, acetate, propionate, or butyrate.

Several specific examples of scent additives can include: 4-hydroxy-2,5-dimethylfuran-3-one (“strawberry furanone”); 2-ethyl-4-hydroxy-5-methyl-3(2H)-furanone (“shoyu furanone”); 5-ethyl-3-hydroxy-4-methyl-2(5H)-furanone (“maple furanone”); 4-acetoxy-2,5-dimethyl-3(2H)-furanone (“strawberry furanone acetate”); 4-hydroxy-5-methyl-3(2H)-furanone (“toffee furanone”), 2,5-dimethyl-3(2H)-furanone (“mango furanone”); 2,5-dimethyl-4-methoxy-3(2H)-furanone (“strawberry furanone methyl ether”); 2-ethyl-4-hydroxy-5-methylfuran-3-one (“ethyl furaneol”); 4,5-dimethyl-3-hydroxy-2,5-dihydrofuran-2-one (“caramel furanone”); and combinations thereof.

In other examples, the scent additive can include an aldehyde, a ketone, an ester, a terpene, an alcohol, or a combination thereof. Specific compounds having desired scents can be selected from these classes of compounds. In some examples, the scent additive can include a methyl octanoate.

In some examples, the scent additive can be a fragrance or flavoring compound that has been previously tested for safety in consumer products. For example, the scent additive can include a compound from a list of substances generally recognized as safe by the United States Food and Drug Administration. In certain examples, the scent additive can include a synthetic flavoring substance. In specific examples, the scent additive can include acetaldehyde, acetoin, anethole, benzaldehyde, N-butyric acid, carvol, cinnemaldehyde, citral, decanal, ethyl acetate, ethyl butyrate, 3-methyl-3-phenyl glycidic acid ethyl ester, ethyl vanillin, geraniol, geranyl acetate, limonene, linalool, linalyl acetate, methyl anthranilate, piperonal, vanillin, or a combination thereof.

The concentration of the scent additive in the scent agent can be sufficient that a noticeable scent is imparted to the finished 3D printed article when the scent agent is applied to the powder build material during 3D printing. Some scent additives can have a more powerful scent than others. Therefore, some scent additives can be used at smaller concentrations while others can be used at greater concentrations. In various examples, the sent additive can be present in the scent agent in an amount from about 0.05 wt % to about 10 wt % based on the total weight of the scent agent. In other examples, the concentration of the scent additive can be from about 0.1 wt % to about 8 wt % or from about 0.5 wt % to about 5 wt %. In some examples, the scent agent can include multiple different scent additives. In such examples, individual scent additive can be included at the concentrations described above or the total amount of scent additive can be at the concentrations described above.

The scent agent can include a liquid vehicle. The scent additive can be dissolved or dispersed in the liquid vehicle. The liquid vehicle can be aqueous or non-aqueous, in various examples. Aqueous liquid vehicles can include more than 50 wt % water and can include organic co-solvent in some cases. Non-aqueous liquid vehicles can be made up entirely of an organic solvent or multiple organic solvents.

The scent agent can also include ingredients to allow the scent agent to be jetted by a fluid jet printhead. In some examples, the scent agent can include jettability imparting ingredients such as those in the fusing agent described above. These ingredients can include a surfactant, dispersant, co-solvent, biocides, viscosity modifiers, materials for pH adjustment, sequestering agents, preservatives, and so on. These ingredients can be included in any of the amounts described above.

In certain examples, the scent agent can include from about 1 wt % to about 10 wt % organic co-solvent, from about 1 wt % to about 20 wt % high boiling point solvent, from about 0.1 wt % to about 2 wt % surfactant, from about 0.1 wt % to about 5 wt % anti-kogation agent, from about 0.01 wt % to about 5 wt % chelating agent, from about 0.01 wt % to about 4 wt % biocide, and the balance can be deionized water.

### Detailing Agents

In further examples, multi-fluid kits or three-dimensional printing kits can include a detailing agent. The detailing agent can include a detailing compound. The detailing compound can be capable of reducing the temperature of the powder bed material onto which the detailing agent is applied. In some examples, the detailing agent can be printed around the edges of the portion of the powder that is printed with the fusing agent. The detailing agent can increase selectivity between the fused and unfused portions of the powder bed by reducing the temperature of the powder around the edges of the portion to be fused.

In some examples, the detailing compound can be a solvent that evaporates at the temperature of the powder bed. In some cases the powder bed can be preheated to a preheat temperature within about 10° C. to about 70° C. of the fusing temperature of the polymer powder. Depending on the type of polymer powder used, the preheat temperature can be in the range of about 90° C. to about 200° C. or more. The detailing compound can be a solvent that evaporates when it comes into contact with the powder bed at the preheat temperature, thereby cooling the printed portion of the powder bed through evaporative cooling. In certain examples, the detailing agent can include water, co-solvents, or combinations thereof. Non-limiting examples of co-solvents for use in the detailing agent can include xylene, methyl isobutyl ketone, 3-methoxy-3-methyl-1-butyl acetate, ethyl acetate, butyl acetate, propylene glycol monomethyl ether, ethylene glycol mono tert-butyl ether, dipropylene glycol methyl ether, diethylene glycol butyl ether, ethylene glycol monobutyl ether, 3-Methoxy-3-Methyl-1-butanol, isobutyl alcohol, 1,4-butanediol, N,N-dimethyl acetamide, and combinations thereof. In some examples, the detailing agent can be mostly water. In a particular example, the detailing agent can be about 85 wt % water or more. In further examples, the detailing agent can be about 95 wt % water or more. In still further examples, the detailing agent can be substantially devoid of radiation absorbers. That is, in some examples, the detailing agent can be substantially devoid of ingredients that absorb enough radiation energy to cause the powder to fuse. In certain examples, the detailing agent can include colorants such as dyes or pigments, but in small enough amounts that the colorants do not cause the powder printed with the detailing agent to fuse when exposed to the radiation energy.

The detailing agent can also include ingredients to allow the detailing agent to be jetted by a fluid jet printhead. In some examples, the detailing agent can include jettability imparting ingredients such as those in the fusing agent described above. These ingredients can include a liquid vehicle, surfactant, dispersant, co-solvent, biocides, viscosity modifiers, materials for pH adjustment, sequestering agents, preservatives, and so on. These ingredients can be included in any of the amounts described above.

In certain examples, the detailing agent can include from about 1 wt % to about 10 wt % organic co-solvent, from about 1 wt % to about 20 wt % high boiling point solvent, from about 0.1 wt % to about 2 wt % surfactant, from about 0.1 wt % to about 5 wt % anti-kogation agent, from about 0.01 wt % to about 5 wt % chelating agent, from about 0.01 wt % to about 4 wt % biocide, and the balance can be deionized water.

### Methods of Making 3D Printed Articles

The present disclosure also describes methods of making three-dimensional printed articles. FIG. 6 shows a flowchart illustrating one example method 600 of making a three-dimensional printed article. The method includes: iteratively applying individual layers of a powder bed material to a powder bed, wherein the powder bed material includes polymer particles 610; based on a three-dimensional object model, selectively applying a fusing agent onto the individual layers of powder bed material, wherein the fusing agent includes water and a radiation absorber, wherein the radiation absorber absorbs radiation energy and converts the radiation energy to heat 620; based on the three-dimensional object model, selectively applying a scent additive to the powder bed material, wherein the scent additive is chemically stable at a melting point temperature of the polymer particles 630; and exposing the powder bed to radiation energy to selectively fuse the polymer particles in contact with the radiation absorber at individual layers and thereby form the three-dimensional printed article 640.

In some examples, the scent agent can be selectively applied on certain areas of the powder bed where the particular scent imparted by the scent agent is desired. As explained above, the scent agent can be applied in the same areas where the fusing agent is applied so that the entire 3D printed article has a uniform scent. In other examples, the scent agent can applied in some portions of the 3D printed article but not in other portions, which can remain unscented. In still further examples, multiple scent agents can be selectively applied to impart multiple scents to different portions of the 3D printed article.

The fusing agent, scent agent, and detailing agent can be jetted onto the powder bed using fluid jet print heads. The amount of the fusing agent used can be calibrated based on the concentration of radiation absorber in the fusing agent, the level of fusing desired for the polymer particles, and other factors. In some examples, the amount of fusing agent printed can be sufficient to contact the radiation absorber with the entire layer of polymer powder. For example, if individual layers of polymer powder is 100 microns thick, then the fusing agent can penetrate 100 microns into the polymer powder. Thus the fusing agent can heat the polymer powder throughout the entire layer so that the layer can coalesce and bond to the layer below. After forming a solid layer, a new layer of loose powder can be formed, either by lowering the powder bed or by raising the height of a powder roller and rolling a new layer of powder.

In some examples, the entire powder bed can be preheated to a temperature below the melting or softening point of the polymer powder. In one example, the preheat temperature can be from about 10° C. to about 30° C. below the melting or softening point. In another example, the preheat temperature can be within 50° C. of the melting of softening point. In a particular example, the preheat temperature can be from about 160° C. to about 170° C. and the polymer powder can be polyamide 12 powder. In another example, the preheat temperature can be about 90° C. to about 100° C. and the polymer powder can be thermoplastic polyurethane. Preheating can be accomplished with a lamp or lamps, an oven, a heated support bed, or other types of heaters. In some examples, the entire powder bed can be heated to a substantially uniform temperature.

The powder bed can be irradiated with a fusing lamp. Suitable fusing lamps for use in the methods described herein can include commercially available infrared lamps and halogen lamps. The fusing lamp can be a stationary lamp or a moving lamp. For example, the lamp can be mounted on a track to move horizontally across the powder bed. Such a fusing lamp can make multiple passes over the bed depending on the amount of exposure to coalesce printed layers. The fusing lamp can be configured to irradiate the entire powder bed with a substantially uniform amount of energy. This can selectively coalesce the printed portions with fusing agent leaving the unprinted portions of the polymer powder below the melting or softening point.

In one example, the fusing lamp can be matched with the radiation absorber in the fusing agent so that the fusing lamp emits wavelengths of light that match the peak absorption wavelengths of the radiation absorber. A radiation absorber with a narrow peak at a particular near-infrared wavelength can be used with a fusing lamp that emits a narrow range of wavelengths at approximately the peak wavelength of the radiation absorber. Similarly, a radiation absorber that absorbs a broad range of near-infrared wavelengths can be used with a fusing lamp that emits a broad range of wavelengths. Matching the radiation absorber and the fusing lamp in this way can increase the efficiency of coalescing the polymer particles with the fusing agent printed thereon, while the unprinted polymer particles do not absorb as much light and remain at a lower temperature.

Depending on the amount of radiation absorber present in the polymer powder, the absorbance of the radiation absorber, the preheat temperature, and the melting or softening point of the polymer, an appropriate amount of irradiation can be supplied from the fusing lamp. In some examples, the fusing lamp can irradiate individual layers from about 0.5 to about 10 seconds per pass

The 3D printed article can be formed by jetting a fusing agent onto layers of powder bed build material according to a 3D object model. 3D object models can in some examples be created using computer aided design (CAD) software. 3D object models can be stored in any suitable file format. In some examples, a 3D printed article as described herein can be based on a single 3D object model. The 3D object model can define the three-dimensional shape of the article. In some examples, the 3D object model can also include a particular 3D portion of the object that is desired to include a scent additive. Thus, this particular portion can define areas where the scent agent will be jetted. Other information may also be included, such as structures to be formed of additional different materials or color data for printing the article with various colors at different locations on the article. The 3D object model may also include features or materials specifically related to jetting fluids on layers of powder bed material, such as the desired amount of fluid to be applied to a given area. This information may be in the form of a droplet saturation, for example, which can instruct a 3D printing system to jet a certain number of droplets of fluid into a specific area. This can allow the 3D printing system to finely control radiation absorption, cooling, color saturation, concentration of the scent additive, and so on. All this information can be contained in a single 3D object file or a combination of multiple files. The 3D printed article can be made based on the 3D object model. As used herein, “based on the 3D object model” can refer to printing using a single 3D object model file or a combination of multiple 3D object models that together define the article. In certain examples, software can be used to convert a 3D object model to instructions for a 3D printer to form the article by building up individual layers of build material.

In an example of the 3D printing process, a thin layer of polymer powder can be spread on a bed to form a powder bed. At the beginning of the process, the powder bed can be empty because no polymer particles have been spread at that point. For the first layer, the polymer particles can be spread onto an empty build platform. The build platform can be a flat surface made of a material sufficient to withstand the heating conditions of the 3D printing process, such as a metal. Thus, “applying individual build material layers of polymer particles to a powder bed” includes spreading polymer particles onto the empty build platform for the first layer. In other examples, a number of initial layers of polymer powder can be spread before the printing begins. These “blank” layers of powder bed material can in some examples number from about 10 to about 500, from about 10 to about 200, or from about 10 to about 100. In some cases, spreading multiple layers of powder before beginning the print can increase temperature uniformity of the 3D printed article. A fluid jet printing head, such as an inkjet print head, can then be used to print a fusing agent including a radiation absorber over portions of the powder bed corresponding to a thin layer of the 3D article to be formed. Then the bed can be exposed to electromagnetic energy, e.g., typically the entire bed. The electromagnetic energy can include light, infrared radiation, and so on. The radiation absorber can absorb more energy from the electromagnetic energy than the unprinted powder. The absorbed light energy can be converted to thermal energy, causing the printed portions of the powder to soften and fuse together into a formed layer. After the first layer is formed, a new thin layer of polymer powder can be spread over the powder bed and the process can be repeated to form additional layers until a complete 3D article is printed. Thus, “applying individual build material layers of polymer particles to a powder bed” also includes spreading layers of polymer particles over the loose particles and fused layers beneath the new layer of polymer particles.

### Definitions

It is noted that, as used in this specification and the appended claims, the singular forms “a,” “an,” and “the” include plural referents unless the context clearly dictates otherwise.

As used herein, “colorant” can include dyes and/or pigments.

As used herein, “dye” refers to compounds or molecules that absorb electromagnetic radiation or certain wavelengths thereof. Dyes can impart a visible color to an ink if the dyes absorb wavelengths in the visible spectrum.

As used herein, “pigment” generally includes pigment colorants, magnetic particles, aluminas, silicas, and/or other ceramics, organo-metallics or other opaque particles, whether or not such particulates impart color. Thus, though the present description primarily exemplifies the use of pigment colorants, the term “pigment” can be used more generally to describe pigment colorants, and also other pigments such as organometallics, ferrites, ceramics, etc. In one specific aspect, however, the pigment is a pigment colorant.

As used herein, “applying” when referring to fusing agent and/or detailing agent, for example, refers to any technology that can be used to put or place the respective fluid agent on or into a layer of powder bed material for forming 3D articles. For example, “applying” may refer to “jetting,” “ejecting,” “dropping,” “spraying,” or the like.

As used herein, “jetting” or “ejecting” refers to applying fluid agents or other compositions by expelling from ejection or jetting architecture, such as ink-jet architecture. Ink-jet architecture can include thermal or piezo architecture. Additionally, such architecture can be configured to print varying drop sizes such as from about 3 picoliters to less than about 10 picoliters, or to less than about 20 picoliters, or to less than about 30 picoliters, or to less than about 50 picoliters, etc.

As used herein, “average particle size” refers to a number average of the diameter of the particles for spherical particles, or a number average of the volume equivalent sphere diameter for non-spherical particles. The volume equivalent sphere diameter is the diameter of a sphere having the same volume as the particle. Average particle size can be measured using a particle analyzer such as the Mastersizer™ 3000 available from Malvern Panalytical. The particle analyzer can measure particle size using laser diffraction. A laser beam can pass through a sample of particles and the angular variation in intensity of light scattered by the particles can be measured. Larger particles scatter light at smaller angles, while small particles scatter light at larger angles. The particle analyzer can then analyze the angular scattering data to calculate the size of the particles using the Mie theory of light scattering. The particle size can be reported as a volume equivalent sphere diameter.

As used herein, the term “substantial” or “substantially” when used in reference to a quantity or amount of a material, or a specific characteristic thereof, refers to an amount that is sufficient to provide an effect that the material or characteristic was intended to provide. The exact degree of deviation allowable may in some cases depend on the specific context. When using the term “substantial” or “substantially” in the negative, e.g., substantially devoid of a material, what is meant is from none of that material is present, or at most, trace amounts could be present at a concentration that would not impact the function or properties of the composition as a whole.

As used herein, the term “about” is used to provide flexibility to a numerical range endpoint by providing that a given value may be “a little above” or “a little below” the endpoint. The degree of flexibility of this term can be dictated by the particular variable and determined based on the associated description herein.

As used herein, a plurality of items, structural elements, compositional elements, and/or materials may be presented in a common list for convenience. However, these lists should be construed as though individual members of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include the numerical values explicitly recited as the limits of the range, and also to include individual numerical values or sub-ranges encompassed within that range as if numerical values and sub-ranges are explicitly recited. As an illustration, a numerical range of “about 1 wt % to about 5 wt %” should be interpreted to include the explicitly recited values of about 1 wt % to about 5 wt %, and also include individual values and sub-ranges within the indicated range. Thus, included in this numerical range are individual values such as 2, 3.5, and 4 and sub-ranges such as from 1-3, from 2-4, and from 3-5, etc. This same principle applies to ranges reciting a single numerical value. Furthermore, such an interpretation should apply regardless of the breadth of the range or the characteristics being described.

### EXAMPLES

The following illustrates examples of the present disclosure. However, it is to be understood that the following are merely illustrative of the application of the principles of the present disclosure. Numerous modifications and alternative devices, methods, and systems may be devised without departing from the spirit and scope of the present disclosure. The appended claims are intended to cover such modifications and arrangements.

### Example 1—Scent Agent Based on Detailing Agent

A sample scent agent was made by adding a scent additive to a detailing agent formulation. The scent additive was 2,5-dimethyl-4-hydroxy-3(2H)-furanone (“strawberry furanone”). The concentration of the scent additive in the scent agent was 0.5 wt %. The detailing agent formulation included over 90 wt % water with the addition of an organic co-solvent, surfactant, anti-kogation agent, chelating agent, biocide, and buffer. The strawberry furanone scent additive dissolved completely in the scent agent. To test jettability of this scent agent, the scent agent was loaded in a 2D inkjet printer and test printed onto a sheet of paper. A small amount of pink dye was added to the scent agent to make the printed scent agent visible on the paper. The scent agent was successfully printed onto the paper, and no issues were detected with respect to nozzle health or decap of the inkjet printer. The scent agent printed on the paper also retained the scent of the strawberry furanone.

### Example 2—Scent Agent Based on Fusing Agent

A second sample scent agent was made by adding strawberry furanone to a fusing agent formulation. The fusing agent included organic co-solvent, surfactant, anti-kogation agent, chelating agent, biocide, carbon black pigment as a radiation absorber, and water. Initially, strawberry furanone was added to the fusing agent at a concentration of 0.5 wt %. However, some aggregation of the black pigment was observed after adding the strawberry furanone. The aggregation most likely indicates an undesirable interaction between the strawberry furanone and the pigment dispersion in the fusing agent. The scent agent was made again with a concentration of 0.2 wt % strawberry furanone in the fusing agent, and no aggregation was observed.

The sample scent agent based on the fusing agent was used as a fusing agent in a 3D printing process. The scent agent was loaded in an HP Multi Jet Fusion 3D™ test printer. The powder bed material was polyamide 12 powder. A 3D printed article was formed using the scent agent as the fusing agent in the 3D printing process. Individual layers of the 3D article was formed by jetting the scent agent onto the powder bed and then fusing the build material where the scent agent was jetted using an infrared fusing lamp. A control 3D printed article was also made using the fusing agent without any strawberry furanone. Both the scented 3D printed article and the control 3D printed article were successfully printed. No visual difference was apparent between the scented 3D printed article and the control 3D printed article.

A blind smell test was used to test for the detectability of the scent from the strawberry furanone in the 3D printed article. The scented 3D printed article and the control 3D printed article were presented to 8 test participants. All of the participants were able to successfully identify the scented 3D printed article and the control 3D printed article based on smell. This shows that the scent additive remained effective after the 3D printing process and that the concentration of the scent additive in the fusing agent was sufficient to impart a noticeable scent.

What is claimed is:

1. A multi-fluid kit for three-dimensional printing comprising:
a fusing agent comprising water and a radiation absorber, wherein the radiation absorber absorbs radiation energy and converts the radiation energy to heat; and
a scent agent comprising water and a scent additive, wherein the scent additive is chemically stable at an elevated temperature from about 70° C. to about 350° C.

2. The multi-fluid kit of claim 1, wherein the scent additive is dissolved in the water of the scent agent.

3. The multi-fluid kit of claim 1, wherein the scent additive is present in the scent agent in an amount from about 0.05 wt % to about 10 wt % based on the total weight of the scent agent.

4. The multi-fluid kit of claim 1, wherein the scent additive comprises a furanone derivative.

5. The multi-fluid kit of claim 1, wherein the scent additive has a general structure selected from: 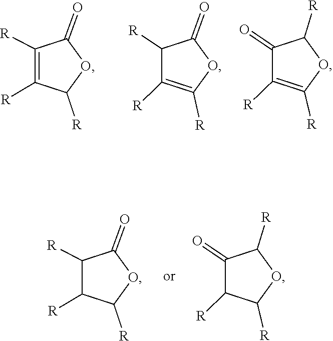
wherein the R groups are independently hydrogen, methyl, ethyl, hydroxyl, methoxy, ethoxy, acetate, propionate, or butyrate.

6. The multi-fluid kit of claim 1, further comprising a detailing agent, wherein the detailing agent comprises a detailing compound, wherein the detailing compound reduces the temperature of powder bed material onto which the detailing agent is applied.

7. A three-dimensional printing kit comprising:
a powder bed material comprising polymer particles;
a fusing agent to selectively apply to the powder bed material, wherein the fusing agent comprises water and a radiation absorber to absorb radiation energy and convert the radiation energy to heat; and
a scent additive included in the fusing agent or in a separate scent agent to selectively apply to the powder bed material, wherein the scent additive is chemically stable at a melting point temperature of the polymer particles.

8. The three-dimensional printing kit of claim 7, wherein the polymer particles comprise polyamide 6, polyamide 9, polyamide 11, polyamide 12, polyamide 66, polyamide 612, thermoplastic polyamide, polyamide copolymer, polyethylene, thermoplastic polyurethane, polypropylene, polyester, polycarbonate, polyether ketone, polyacrylate, polystyrene, polyvinylidene fluoride, polyvinylidene fluoride copolymer, poly(vinylidene fluoride-trifluoroethylene), poly(vinylidene fluoride-trifluoroethylene-chlorotrifluoroethylene), wax, or a combination thereof.

9. The three-dimensional printing kit of claim 7, wherein the scent additive is present in the separate scent agent in an amount from about 0.05 wt % to about 10 wt % based on the total weight of the scent agent, wherein the scent agent further comprises water.

10. The three-dimensional printing kit of claim 7, wherein the scent additive comprises a furanone derivative.

11. The three-dimensional printing kit of claim 7, wherein the scent additive has a general structure selected from: 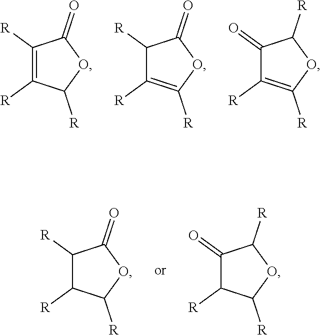
wherein the R groups are independently hydrogen, methyl, ethyl, hydroxyl, methoxy, ethoxy, acetate, propionate, or butyrate.

12. A method of making a three-dimensional printed article comprising:
iteratively applying individual layers of a powder bed material to a powder bed, wherein the powder bed material comprises polymer particles;
based on a three-dimensional object model, selectively applying a fusing agent onto the individual layers of powder bed material, wherein the fusing agent comprises water and a radiation absorber, wherein the radiation absorber absorbs radiation energy and converts the radiation energy to heat;
based on the three-dimensional object model, selectively applying a scent additive to the powder bed material, wherein the scent additive is chemically stable at a melting point temperature of the polymer particles; and
exposing the powder bed to radiation energy to selectively fuse the polymer particles in contact with the radiation absorber at individual layers and thereby form the three-dimensional printed article.

13. The method of claim 12, wherein applying the scent additive comprises applying a scent agent that is separate from the fusing agent, wherein the scent additive is present in the scent agent in an amount from about 0.05 wt % to about 10 wt % based on the total weight of the scent agent, wherein the scent agent further comprises water, and wherein the scent additive is dissolved in the water.

14. The method of claim 12, wherein applying the fusing agent and scent additive comprises:
ejecting the fusing agent from jetting architecture, wherein the scent additive is included in the fusing agent, or
ejecting the fusing agent and a separate scent agent from jetting architecture, wherein the scent additive is included in the separate scent agent.

15. The method of claim 12, wherein the scent additive comprises a furanone derivative.
